(19) United States
(12) Patent Application Publication
(10) Pub. No.: US 2004/0262488 A1
(43) Pub. Date: Dec. 30, 2004

(54) Outboard motor lift

(76) Inventor: Guy Ronald Kozubski, McGehee, AR (US)

Correspondence Address: DENNIS B. HAASE, P.O. BOX 6206, HOT SPRINGS, AR, 71902-6206, US

(21) Appl. No.: 10/609,354

(22) Filed: Jun. 30, 2003

(51) Int. Cl. F16M 1/00

(52) U.S. Cl. 248/642

(57) ABSTRACT

For particular use on a shallow draft boat with an outboard motor traveling a course in shallow water with both expected and unexpected sub surface impediments along the way, an improved lift assembly in which the motor responds automatically when encountering a sub surface impediment by raising vertically so that the thrust of the propellor always remains at its optimum in the direction of the movement of the boat, while avoiding damage which could result from forceful contact with such impediment, and further having a manual lifting mechanism to permit the boatman in the boat to consciously avoid known potentially injurious conditions.

The present invention relates generally to systems for manually and automatically lifting an outboard motor to avoid subsurface impediments, and to permit travel in shallow water, and more particularly, to improvements in such systems which allow such adjustments without sacrifice to the efficiency of the motor.

### BACKGROUND OF THE INVENTION

1. Field of the Invention

Motorized water activities, once a recreational pastime, have become very big business. While the recreational element has not diminished, competition in the area of, for example, fishing, has become intense, and the amount of money now spent on what was once a passive activity has reached the level of astounding to many.

Whether it be in competition, or a form of relaxation, taking the boat out on the lake or river has become the passion of increasing numbers of folks from all walks of life, and the number of products which entered the market place with the goal of enhancing the experience at all levels has exploded.

Boating is not restricted to deep water venues, and, in fact, those who fish, as one example, often find their quarry in more shallow areas. In other instances, convenient waterways may simply be more shallow, causing the enthusiast to accept the reality that he or she may encounter sandbars, sunken logs, stumps and sub surface debris, all of which tends to limit the scope of the boating activity, although not the enthusiasm with which its devotees meet the challenge.

In a commercial context, fisheries, for example catfish farms, use very shallow, yet large area, ponds to grow and harvest the fish, and boats equipped with the lift system of the present invention are ideal in such environments.

In addition to the foregoing, it will become clear that the present invention will have a beneficial impact on law enforcement and rescue operations where there is flooding, and sub surface hazzards are commonplace.

2. Overview of Related Art

As the number of persons willing to row a boat as a means of motive power diminishes, motors and, in particular, outboard motors, have become the norm. Once a relatively inexpensive motor in the five to fifteen horse range was commonplace, but as the boating public displayed their willingness to spend dollars to get more and better, product providers eagerly filled the pipeline with supply to meet the demand, and twin two fifties are available for those who will pay the cost.

Addressing the acknowledged problem attendant more shallow waters, however, boats with more shallow drafts, and smaller motors, generally considered to be in a range of around one horse to 50 horsepower, remain at the peak of demand for those who most often boat in waters where the water is very shallow, and/or subsurface conditions may cause damage to equipment, and/or disruption of, or to, boating activity while the boat is under power. It is to this concern that the present improved lift device is directed.

It has long been acknowledged that in order to avoid damage to the prop, or the lower transmission unit, of an outboard motor, it is necessary, when cruising in shallows, and/or approaching subsurface hazards, to lift the motor to avoid such conditions. In our U.S. Pat. No. 5,188,549, for example, we proposed a solution in the form of a device which would permit the prop of the motor to be tilted upwardly about the transom of the craft to which the motor is mounted, upon encountering a subsurface hazard. We included apparatus which would permit the user to tilt the motor manually, and even to select a number of suitable angles which could be achieved by such action while the motor was under power.

In Griffiths et al. U.S. Pat. No. 4,872,859 the inventors felt a need to be able to lift a relatively heavy motor with ease when loading the boat of a trailer or the like, and so they came up with a lift which was power assisted by means a hydraulic cylinder, and further provided for the locking of the motor in the uplifted position. While Griffiths et al. declares their intention to overcome the more cumbersome power assisted lifts for larger motors, then available, Griffiths et al. neither envisioned the problems addressed herein, nor offered a plausible solution.

Harmon, in his 1938 U.S. Pat. No. 2,138,600, proposed to manually position an outboard by means of a pair of semi circular flanges formed with peripheral apertures so that the motor could be “pinned” in a particular position in or out of the water.

Machlan U.S. Pat. No. 3,032,304 uses a chain to lift the outboard and to latch it in the up position. He addresses concerns relative to providing a small motor for a sail boat, or even carrying a small motor. If the motor gets heavier, the tougher it is to lift, and the chain approach leaves much to be desired.

For those who find the chain a bit cumbersome, there is the more direct, lever approach of Staley U.S. Pat. No. 2,785,744. Staley uses an operating lever 232, which must be swung from the extreme right to the extreme left in order to raise the motor, a feat which could not reasonably be accomplished by a person of normal stature from within the boat, and with some difficulty no matter where the operator is located.

Another variation on the use of a handle or lever is found in Mayfield U.S. Pat. No. 5,522,578 where an over center linkage raises the motor, but the operator must stand and pull with considerable effort to swing the handle 58 from its FIG. 1 position to its FIG. 2 position.

While there appears to be no lack of ideas as to how best to raise and lower a motor relative to the transom of a small shallow draft boat, each suffers from one or more deficiencies which render them less than satisfactory in many situations commonly encountered by the boatman in shallow water.

### SUMMARY OF THE INVENTION

The present invention teaches a lift system for selectively, and also automatically, raising and lowering an outboard motor to permit use in shallow water, and where sub surface impediments are to be anticipated, which system retains many of the benefits derived from our '549 patent while providing greater efficiency in operation of the motor by assuring that optimum thrust developed by the motor at any given time is efficiently transmitted to the boat.

It is another objective of the present invention to provide an easily manipulated lift system which functions automatically, as well as manually, to raise and lower an outboard motor relative to the transom of a shallow draft boat in response to varying subsurface conditions found in the body of water being traversed by the boat.

Yet another objective to be accomplished by the invention is to provide the foregoing benefits to the boatman from within the boat, and without undue effort, even where the motor is heavier.

A further objective of the present invention is to permit lifting and lowering of an outboard motor relative to the transom of a boat to which it is attached, in increments along a vertical path and while the motor is operating, so as to maintain the thrust of the propellor in the plane of movement of the boat, without interruption in either speed or course of the boat.

The foregoing, as well as other objects and advantages of the improved lift system of the present invention, when the following detailed description of a preferred embodiment is considered in light of the drawings, wherein:

### BRIEF DESCRIPTION OF THE DRAWINGS

FIG. 1 is a perspective view of the lift system mechanism of the present invention showing its attachment to the transom of a boat, and with the outboard motor removed in order to display the mechanism with considerable clarity;

FIG. 2 is a view of the lift mechanism from a perspective opposite from that of FIG. 1, and with the transom of the boat removed in order that further details of the mechanism may be observed;

FIG. 3 is a side elevation of the mechanism of FIG. 1 with the mechanism attached to the boats transom;

FIG. 4 is a side elevation of the lift system mechanism of the present invention, similar to that of FIG. 3, but with the motor attached, and raised by a subsurface impediment, so as to be held above the impediment, the propellor being in line with the boat's keel, while maintaining the thrust of the motor's propellor in line with the keel of the boat;

FIG. 5 is a view similar in position to that of FIG. 4, but with the outboard motor in its fully lowered position;

FIG. 6 is perspective view in the nature of FIG. 1, except the motor mounting plate is removed to expose further details of the lift mechanism;

FIG. 7 is a side elevation of an outboard motor being manually positioned relative to the transom of the boat, and with the boat partially sectioned to provide necessary detail of the relationship;

FIG. 8 is a perspective view, similar to FIG. 6, of the lift mechanism, partially sectioned and in a manually raised position intermediate to its fully raised position;

FIG. 9 is a view similar to FIG. 8, but with the motor in its fully raised position;

FIG. 10 is a view of the lift system of the present invention, partially sectioned to illustrate detail of the system as it appears with the motor lifted to its maximum lifted position; and

FIG. 11 is a partially sectioned and fragmented view of the rachet mechanism which permits lifting of the motor in several increments.

### DETAILED DESCRIPTION OF A PREFERRED EMBODIMENT

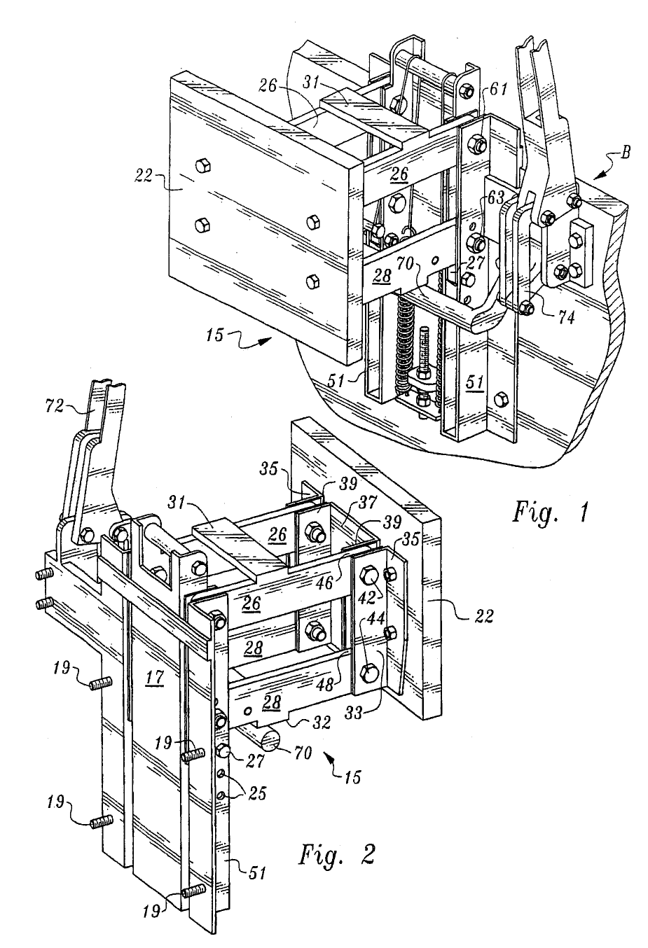

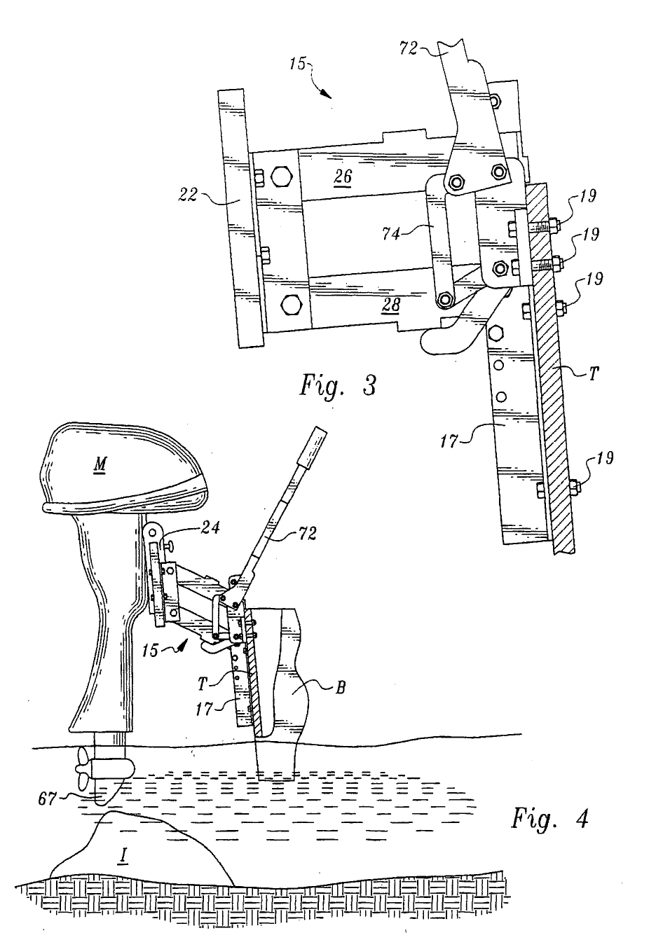

With reference now to the drawings, and initially to FIGS. 1 and 2, an improved lift system for securing an outboard motor M to a small, typically shallow draft boat B is indicated at 15.

The mechanism of the lift system is secured to the transom T of the boat B, by means of a plate 17, through which a number of strategically placed fasteners 19, of any number of well known types, pass into and through the transom T.

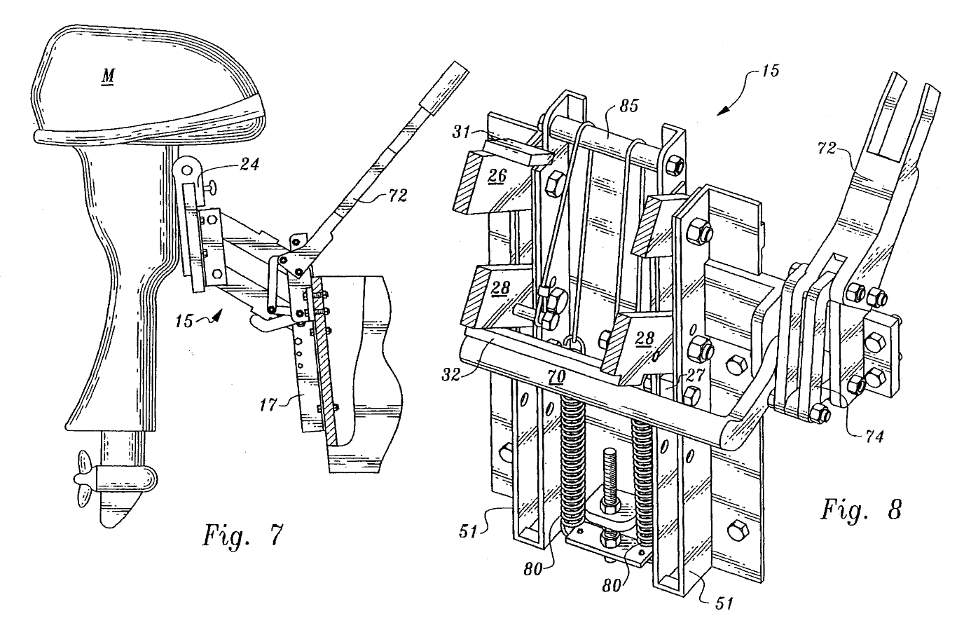

An outboard motor M is secured at the end of the mechanism 15 opposite the plate 17, as seen in FIGS. 4, 5, 7 and 9. For this purpose, a motor mount 22 is provided and, in its most basic form, is preferably a flat member of uniform thickness, at least at its uppermost edge. The motor mount 22, in keeping with the invention, is essentially parallel with the plate 17 and, coincidently, parallel to the transom of the boat B. The motor M clamps to the motor mount 22, as seen in FIG. 4, for example, by means of clamps 24.

The initial depth of the motor is adjustable, and a series of apertures 25 are provided along the edge of the plate 17 for that purpose. Blocks 26 are held in place by fastener 27 to position the links initially, and thus the depth of the motor relative to the bottom or keel of the boat.

The principal objects of the invention are achieved by maintaining the orientation of the motor relative to the boat throughout the range of operation of the lift system 15, and, to this end, parallel four bar link mechanisms are provided between the plate 17 and the motor mount 22. With reference to FIGS. 1 and 2, upper links 26 are provided, and spaced from a pair of lower links 28. Each of an upper link and a lower link are coplaner, and the planes of each such pair are parallel. Additionally the upper links 26 and the lower links 28 are, themselves, parallel. Pairs of upper links are tied together by an upper cross bar 31. In a similar fashion, a lower cross bar 32 ties adjacent pairs of lower links 28 together. In this manner, the links operate in unison, as will be hereinafter discussed.

In accordance with the objectives of the invention, each of the links 26 are secured for rotation at one end in a right angle bracket assembly 33 secured to the motor mount 22 in any suitable fashion. The assembly 33 is formed by side angle irons 35 and a center plate 37 having upstanding flanges 39.

The bracket assembly 33 provides spaces, or slots, between the various elements, which spaces are sufficiently greater than the thickness of the links which form the four bar mechanism. The slots so formed are vertical in orientation so that the links may move freely upwardly and downwardly about fasteners 42 and 44. The fasteners 42 and 44 pass through the flanges transverse to the slot and hold the ends 46 and 48 of operating pairs of an upper link 26 and a lower link 28 for rotation about the fasteners 42 and 44.

In a similar fashion, a bracket assembly is secured to the plate 17 and, in the same manner as described with respect to the bracket assembly 33, provides vertical slots within which the opposite ends 56 and 58 of the links 26 and 28 are secured for limited rotation in an essentially vertical plane about fasteners 61 and 63. In order to assure free movement of the links 26 and 28, the slots formed by the bracket assemblies 33 and 51 are coplaner, thereby simplifying the construction of the linkage which will be straight along their longitudinal axes.

Referring to FIG. 4, it will now become apparent to those skilled in the art, that when the vertical guide plane 67 of the motor M is engaged by some sub surface impediment I, the motor will be urged vertically upwardly and out of the way of the impediment. Such movement is readily accomplished while the motor is operating, and the direction of the thrust being developed by the propellor remains optimum in the direction of the movement of the boat, thereby avoiding damage to the motor and accomplishing one of the important objectives established for the lift assembly 15.

While the foregoing describes the operation of the lift assembly of the present invention when an unexpected impediment is encountered, it is also important that the boatman be able to establish an orientation of the motor when conditions are known and to be anticipated.

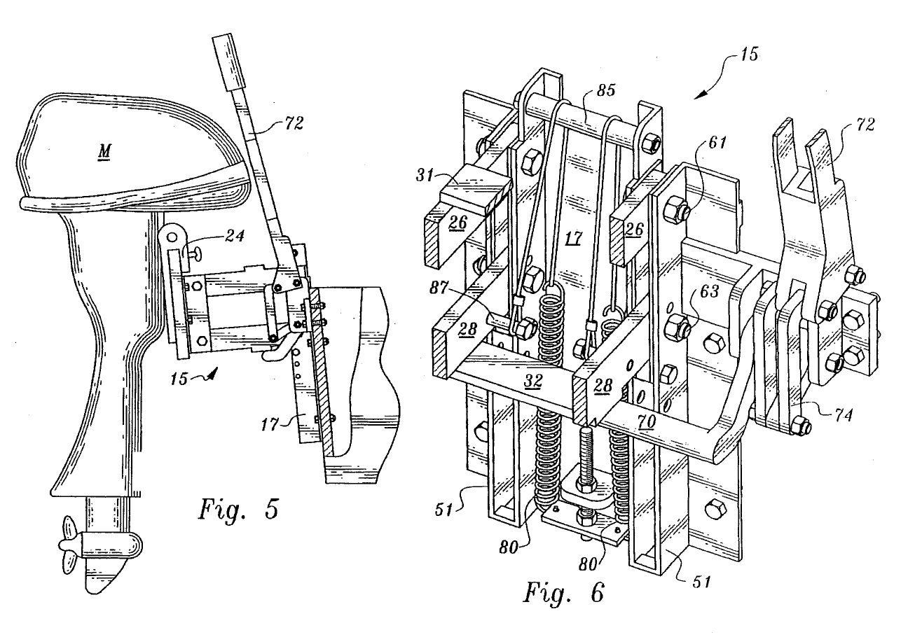

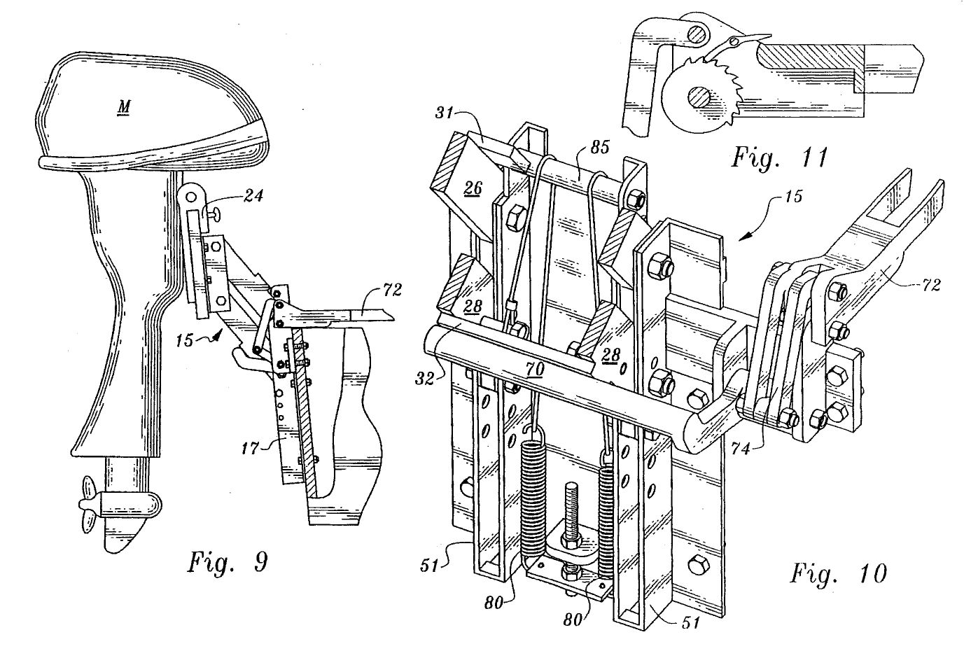

To this end, manual lift apparatus is provided which will establish a predetermined position for the motor when the boat is to travel through shallow areas with known impediments. More specifically, and with initial reference to FIGS. 1, 4, 7 and 9, a lift bar 70 passes beneath the lower links 28 where it engages the lower cross bar 32. The cross bar is linked to a handle 72 by means of a link 74. Referring to FIG. 11, a ratchet wheel 76 is engaged by a detent 78. A trigger mechanism (not shown) on the handle 72, which may take any one of several well known forms, rotates the detent away from the ratchet 76 permitting the handle to be moved from a full release position as shown in FIG. 5, where the motor is at full depth, to a full up position as shown in FIG. 9, where the motor is out of the water. Clearly by manipulation of the trigger, any number of intermediate positions can be achieved, depending on the conditions which are present along the course to be traversed by the boat.

While the present lift system is contemplated as having particular value for small motors, it is within the contemplation of the invention that larger motors may be mounted on the same system. In order to facilitate operation under heavier loads, springs 80 are provided, and may be seen in several figures of the drawings, but perhaps best in FIG. 6. The springs 80 are secured at one end to an adjustment plate 83. The opposite end of each spring is passed over a tensioning rung 85 and, thence, attached to a lower link 28 by means of a fastener 87. In this manner, the four bar linkage is biased upwardly which provides two salutary benefits. First, it lightens the load on the lift system due to the weight of the motor and, when an impediment is encountered, the force to move the motor upwardly and out of the way is less than if the springs were not present. Secondly, the force on the handle 72 needed to lift the motor is lightened, meaning less physical force is required by the boatman, and lighter components can be used, reducing the cost of the lift system.

It will be appreciated that the preceding description is provided with respect to a preferred embodiment, and variations in the structure may be perceived by those skilled in the art, while being well within the contemplation of the invention.

What we claim as our invention is:

1. An outboard motor lift assembly for shallow draft boats being operated in shallow water in which it may encounter sub surface impediments in the course of the boat's travels, comprising;
a plate, said plate secured to the transom of the boat;
a pair of upper links, said links tied together by an upper cross bar;
a pair of lower links, said lower links tied together by a lower cross bar;
a bracket assembly on said plate, one end of said upper links and said lower links secured in said bracket assembly;
a motor mount, said motor mount having a bracket assembly thereon, and the other end of said upper links and said lower links being rotatably mounted in said bracket assembly on said motor mount;
a motor selectively secured to said motor mount; said motor being automatically raised in a vertical path in response to contact with an underwater impediment.

2. The outboard motor lift of claim 1, having a manual lift assembly, said manual lift assembly including a lift bar, said lift bar disposed in contact with said lower links, and a handle, said handle moveable within the boat to raise and lower said lift bar against said lower links to thereby manually raise and lower said motor in a vertical plane, and a rachet, said rachet being selectively engageable to establish a predetermined position of said motor.

3. The outboard motor lift of claim 1, having a block, said block being positioned on said plate in the plane of said lower link, said block being contacted by said lower link to establish the initial depth of said motor in the water.

4. The outboard motor lift of claim 1, wherein at least one spring is provided, said spring being tensioned between said plate and said lower links so as to assist in lifting said motor.

5. The outboard motor lift of claim 1, wherein springs are tensioned between said plate and said linkage to normally bias said motor upwardly relative to the boat.

6. An outboard motor lift assembly for use in selectively raising an outboard motor relative to a shallow draft boat when the boat is running in shallow water and automatically lifting the motor when encountering sub surface impediments in the course of the boat's travel comprising:
a plate, said plate secured to the transom of the boat;
a motor mount, said motor mount disposed in space relation to said plate and having an outboard motor removably secured thereto;
linkage interconnecting said plate and said motor mount, said linkage adapted to cause said motor to be raised automatically in a vertical direction upon encountering impediments during the course of movement of the boat;
a manual lift mechanism, said lift mechanism being fully operable within the boat; said lift mechanism including a handle, and a lift bar, said lift bar linked to said handle, and in contact with said linkage such that downward movement of said handle causes the motor to be lifted.

7. The outboard motor lift of claim 6, wherein springs are tensioned between said plate and said linkage to normally bias said motor upwardly relative to the boat.

8. The outboard motor lift of claim 6, where said linkage comprises a pair of upper links, said upper links being interconnected with one another;
a pair of lower links, said lower links being interconnected to one another;
said upper links and said lower links being rotatably secured to and between said plate and said motor mount so as to permit movement of said motor in a vertical direction relative to the boat.

9. The outboard motor lift of claim 6, wherein said lift mechanism includes a ratchet, said handle being selectively engageable with said ratchet so as to position the motor along a vertical path at various levels relative to the boat.

10. The outboard motor lift of claim 6, having a block, said block being positioned on said plate in the plane of said lower link, said block being contacted by said lower link to establish the initial depth of said motor in the water.
